(19) United States
(12) Patent Application Publication
(10) Pub. No.: US 2025/0092232 A1
(43) Pub. Date: Mar. 20, 2025

(54) CELLULOSE FIBER COMPOSITE RESIN COMPOSITION, CELLULOSE FIBER COMPOSITE RESIN MOLDED BODY AND METHOD FOR PRODUCING CELLULOSE FIBER COMPOSITE RESIN COMPOSITION

(71) Applicant: Panasonic Intellectual Property Management Co., Ltd., Osaka (JP)

(72) Inventors: MASAYOSHI IMANISHI, Fukui (JP); MASASHI HAMABE, Osaka (JP); TOSHIFUMI NAGINO, Osaka (JP); SHOUMA NISHINO, Fukui (JP); AMI FUKU, Osaka (JP)

(21) Appl. No.: 18/969,365

(22) Filed: Dec. 5, 2024

Related U.S. Application Data
(63) Continuation of application No. PCT/JP2023/019836, filed on May 29, 2023.

(30) Foreign Application Priority Data
Jun. 14, 2022 (JP) 2022-095908

(51) Int. Cl. C08L 1/02; C08J 3/205; C08J 5/04

(52) U.S. Cl. CPC C08L 1/02; C08J 3/205; C08J 5/045; C08J 2301/02; C08J 2423/06; C08J 2423/12; C08J 2423/26; C08L 2205/025; C08L 2205/035; C08L 2205/16

(57) ABSTRACT

A cellulose fiber composite resin composition includes: a base resin; a cellulose fiber, and a dispersant. The cellulose fiber is contained in an amount of 50 mass % or more and 90 mass % or less, the cellulose fiber has an average particle diameter of 10 μm or more and 70 μm or less, the cellulose fiber includes a cellulose fiber having a particle diameter of 710 μm or less in a ratio of 95% or more, and the cellulose fiber includes a cellulose fiber having an aspect ratio of 5 or more and 100 or less in a ratio of 95% or more.

### TECHNICAL FIELD

The present disclosure relates to a cellulose fiber composite resin composition and a cellulose fiber composite resin molded body that is a molded body including the cellulose fiber composite resin composition.

### BACKGROUND ART

So-called “general-purpose plastics” such as polyethylene (PE), polypropylene (PP), polystyrene (PS), and polyvinyl chloride (PVC) have characteristics of being relatively inexpensive, having a weight as small as a fraction of the weight of metal or ceramics, and being easy to process such as molding. Therefore, general-purpose plastics are used as materials of various daily commodities such as bags, various packaging, various containers, and sheets, and industrial components such as automobile components and electrical components, daily necessities, and miscellaneous goods.

However, general-purpose plastics have disadvantages such as insufficient mechanical strength. Therefore, general-purpose plastics do not have sufficient properties required for materials used for various industrial products including machine products such as automobiles and electric/electronic/information products, and the application range thereof is currently limited.

On the other hand, so-called “engineering plastics” such as polyacetal (POM), polyamide (PA), polycarbonate (PC), and fluororesin are excellent in mechanical properties, and are used for various industrial products including machine products such as automobiles, and electric/electronic/information products. However, engineering plastics have problems of being expensive, difficult to recycle monomers, and imposing a large environmental load.

Therefore, there has been a demand for greatly improving the material properties (mechanical strength and the like) of general-purpose plastics. As a method for improving the material properties of general-purpose plastics, a technique for producing a composite resin by blending two or more types of resins or additives such as fillers is known. In particular, natural fibers, glass fibers, carbon fibers, and the like, which are fibrous fillers, are used for the purpose of improving the mechanical strength. Among them, organic fibrous fillers such as cellulose have attracted attention in recent years as reinforcing fibers because they are inexpensive and excellent in environmental properties at the time of disposal.

As one of the applications of the composite resin, the composite resin is used for components such as housings of household electric appliances, and interior and exterior components of automobiles. Among the components, an external component, which is directly exposed to human eyes, becomes poor in appearance and cannot be used as a product when a foreign substance or the like is present. When a filler is added to a resin, the filler is a material different from that of the resin. Therefore, particularly when a hydrophilic filler such as cellulose and a resin having high lipophilicity are combined, cellulose fibers are not well dispersed in the resin, and cellulose fibers may aggregate with each other to form aggregates. Since the aggregate is larger than the fiber alone, there is a problem that an aggregate having a size that can be visually confirmed (white spot or black spot) is formed, resulting in poor appearance. In addition, since the aggregate serves as a starting point of fracture when a stress load is applied, it is important to suppress the formation of the aggregate also from the viewpoint of mechanical characteristics. In PTL 1, the cellulose fiber dried material is controlled in size, aggregation state of cellulose molecules, and interparticle interaction to suppress the formation of aggregates and suppress the formation of black spots caused by the aggregates.

### CITATION LIST

### Patent Literature

PTL 1: Unexamined Japanese Patent Publication No. 2021-169577

### SUMMARY OF THE INVENTION

However, in the composite resin described in PTL 1, a cellulose dried material in which a large particle having a particle diameter of more than 710 μm is present at a constant ratio is kneaded into the resin. Therefore, there is a problem that the particles serve as a starting point to generate aggregation. In addition, since the cellulose fiber is a nanofiber and has a large aspect ratio, the cellulose fiber has a large surface area. Therefore, the cellulose fiber is difficult to add in high concentration.

The present disclosure is intended to solve the above-mentioned conventional problems, and an object of the present disclosure is to provide a cellulose fiber composite resin composition that suppresses generation of aggregates, has good appearance, and contains cellulose fibers in high concentration.

In the present disclosure, the cellulose fiber composite resin composition includes: a base resin; a cellulose fiber; and a dispersant. The cellulose fiber is contained in an amount of 50 mass % or more and 90 mass % or less, the cellulose fiber has an average particle diameter of 10 μm or more and 70 μm or less, the cellulose fiber includes a cellulose fiber having a particle diameter of 710 μm or less in a ratio of 95% or more, and the cellulose fiber includes a cellulose fiber having an aspect ratio of 5 or more and 100 or less in a ratio of 95% or more. The aspect ratio is a ratio between a fiber length of a cellulose fiber and a fiber diameter of a cellulose fiber.

According to the cellulose fiber composite resin composition of the present disclosure, even when the cellulose fiber is combined with the base resin in a concentration as high as 50 mass % or more, contact and entanglement between cellulose fibers can be suppressed, generation of aggregates can be suppressed, and a composite resin composition having good appearance can be obtained.

### BRIEF DESCRIPTION OF THE DRAWINGS

FIG. 1 is a schematic cross-sectional view illustrating the cross-sectional structure of a cellulose fiber composite resin molded body including a cellulose fiber composite resin composition according to the first exemplary embodiment.

FIG. 2 is a chart showing conditions and measurement results in Examples 1 to 4 and Comparative Examples 1 to 4.

### DESCRIPTION OF EMBODIMENT

The cellulose fiber composite resin composition according to the first embodiment includes: a base resin; a cellulose fiber; and a dispersant, wherein the cellulose fiber is contained in an amount of 50 mass % or more and 90 mass % or less, the cellulose fiber has an average particle diameter of 10 μm or more and 70 μm or less, a cellulose fiber having a particle diameter of 710 μm or less is included in a ratio of 95% or more, and a cellulose fiber having an aspect ratio (fiber length/fiber diameter) of 5 or more and 100 or less is included in a ratio of 95% or more.

The cellulose fiber composite resin composition according to the second embodiment is that: in the first embodiment, the cellulose fiber may include a cellulose fiber that is bent at 90° or more in a ratio of 30% or less.

The cellulose fiber composite resin composition according to the third embodiment is that: in the first embodiment, a low molecular weight resin having a molecular weight of 1000 or more and 50000 or less may be included.

The cellulose fiber composite resin composition according to the fourth embodiment is that: in the third embodiment, the low molecular weight resin may be contained in an amount of 0.5 mass % or more and 20 mass % or less with respect to 100 mass % of the cellulose fiber.

The cellulose fiber composite resin molded body according to the fifth embodiment includes the cellulose fiber composite resin composition according to any one of the first to fourth embodiments.

The cellulose fiber composite resin molded body according to the sixth embodiment is that: in a skin layer including a surface of the cellulose fiber composite resin molded body, 70% or more of the cellulose fiber may have a fiber length direction that is oriented at an angle of 0° or more and 30° or less against the surface of the cellulose fiber composite resin molded body.

The method for producing a cellulose fiber composite resin composition according to the seventh embodiment includes: a preparation step of preparing a base resin, a cellulose fiber, and a dispersant; and a kneading step of kneading the base resin, the cellulose fiber, and the dispersant to obtain a cellulose fiber composite resin composition.

The method for producing a cellulose fiber composite resin composition according to the eighth embodiment is that: in the seventh embodiment, a mixing step of adhering an additive resin having a powdery form or a liquid form to the cellulose fiber may be further included.

The method for producing a cellulose fiber composite resin composition according to the ninth embodiment is that: in the eighth embodiment, the additive resin may be a powdery resin having an average particle diameter of 100 μm or more and 1000 μm or less.

Hereinafter, the cellulose fiber composite resin composition according to the exemplary embodiment and the cellulose fiber composite resin molded body including the composition will be described with reference to the accompanying drawings. In the following description, the same components are denoted by the same reference marks, and the description thereof is appropriately omitted.

### First Exemplary Embodiment

### <Cellulose Fiber Composite Resin Composition and Molded Body>

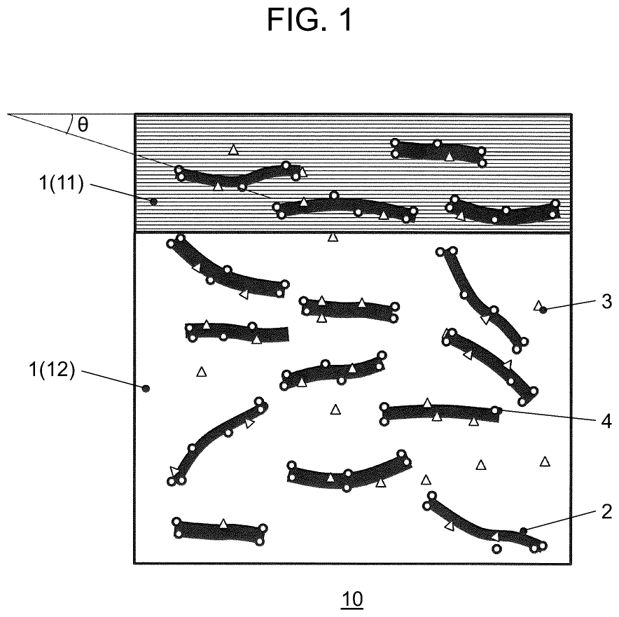

FIG. 1 is a schematic cross-sectional view illustrating the cross-sectional structure of cellulose fiber composite resin molded body 10 including a cellulose fiber composite resin composition according to the first exemplary embodiment.

The cellulose fiber composite resin composition included in cellulose fiber composite resin molded body 10 according to the first exemplary embodiment includes base resin 1, cellulose fiber 2, dispersant 3, and low molecular weight resin 4. In the cellulose fiber composite resin composition, as shown in FIG. 1, cellulose fiber 2, dispersant 3, and low molecular weight resin 4 are dispersed in the matrix of base resin 1, and dispersant 3 is present at the interface between cellulose fiber 2 and base resin 1 or the like. Low molecular weight resin 4 is mainly present around cellulose fiber 2. As shown in FIG. 1, cellulose fiber composite resin molded body 10 is roughly made of two layers, skin layer 11 on the surface and core layer 12 inside. When the molten resin enters a mold during molding, the resin surface in contact with the mold surface is rapidly cooled, and the rest, the inside of the resin, is slowly cooled. Since the cooling rate is different between the surface and the inside, characteristics such as crystallinity are different, and it is possible to distinguish between skin layer 11 on the resin surface and core layer 12 inside the resin by microscopic observation or the like. In the present specification, the layer at the surface of the molded body that is rapidly cooled during molding is defined as skin layer 11, and the layer inside the molded body that is slowly cooled during molding is defined as core layer 12.

Hereinafter, each member constituting the cellulose fiber composite resin composition included in cellulose fiber composite resin molded body 10 will be described.

### <Base Resin>

In the first exemplary embodiment, base resin 1 is preferably a thermoplastic resin in order to ensure good moldability. Examples of the thermoplastic resin include olefin-based resins (including cyclic olefin-based resins), styrene-based resins, (meth) acrylic resins, organic acid vinyl ester-based resins or derivatives thereof, vinyl ether-based resins, halogen-containing resins, polycarbonate-based resins, polyester-based resins, polyamide-based resins, thermoplastic polyurethane resins, polysulfone-based resins (such as polyethersulfone and polysulfone), polyphenylene ether-based resins (such as polymers of 2,6-xylenol), cellulose derivatives (such as cellulose esters, cellulose carbamates, and cellulose ethers), silicone resins (such as polydimethylsiloxane and polymethylphenylsiloxane), and rubbers or elastomers (such as diene rubbers including polybutadiene and polyisoprene, styrene-butadiene copolymers, acrylonitrile-butadiene copolymers, acrylic rubbers, urethane rubbers, and silicone rubbers). The resin may be used alone or in combination of two or more thereof. Note that base resin 1 is not limited to the above materials as long as it has thermoplastic properties.

Among these thermoplastic resins, base resin 1 is preferably an olefin-based resin having a relatively low melting point. Examples of the olefin-based resin include a homopolymer of an olefin-based monomer, a copolymer of an olefin-based monomer, and a copolymer of an olefin-based monomer and another copolymerizable monomer. Examples of the olefin-based monomer include chain olefins (α-C2-20 olefins such as ethylene, propylene, 1-butene, isobutene, 1-pentene, 4-methyl-1-pentene, and 1-octene), and cyclic olefins. These olefin-based monomers may be used alone or in combination of two or more types thereof. Among the olefin-based monomers, chain olefins such as ethylene and propylene are preferable. Examples of other copolymerizable monomers include fatty acid vinyl esters such as vinyl acetate and vinyl propionate; (meth) acrylic monomers such as (meth) acrylic acid, alkyl (meth) acrylate, and glycidyl (meth) acrylate; unsaturated dicarboxylic acids or anhydrides thereof such as maleic acid, fumaric acid, and maleic anhydride; vinyl esters of carboxylic acids (for example, vinyl acetate, vinyl propionate, and the like); cyclic olefins such as norbornene and cyclopentadiene; and dienes such as butadiene and isoprene. These copolymerizable monomers may be used alone or in combination of two or more. Specific examples of the olefin-based resin include polyethylene (low density, medium density, high density, or linear low density polyethylene, etc.), polypropylene, and copolymers of chain olefins (particularly α-C2-4 olefins) such as an ethylene-propylene copolymer, and a terpolymer such as ethylene-propylene-butene-1.

### <Cellulose Fiber>

In the first exemplary embodiment, examples of cellulose fiber 2 include a cellulose fiber and a lignocellulose fiber. Examples of the raw material of the cellulose fiber and the lignocellulose fiber include natural materials such as wood (needle-leaved tree, broad-leaved tree), cotton linters, kenaf, Manila hemp (abaca), sisal hemp, jute, sabai grass, esparto grass, bagasse, rice straw, straw, reed, and bamboo. Modified cellulose fibers whose surface and terminal are chemically modified with an acid, an amine, an epoxy, or the like may be used. Among these cellulose fibers, cellulose fiber 2 is preferably a cellulose fiber made from pulp. The cellulose fiber preferably uses a raw material from which impurities such as lignin and hemicellulose are removed and in which the cellulose ratio is 70% or more. The raw material is not limited to pulp.

### <Dispersant>

In the first exemplary embodiment, examples of dispersant 3 include various titanate-based coupling agents, silane coupling agents, modified polyolefins obtained through graft modification with unsaturated carboxylic acid, maleic acid, maleic anhydride, or an anhydride thereof, fatty acids, fatty acid metal salts, and fatty acid esters. The silane coupling agent is preferably unsaturated hydrocarbon-based or epoxy-based. The surface of the dispersant may be treated and modified with a thermosetting or thermoplastic polymer component. Dispersant 3 is appropriately selected depending on the combination of base resin 1 and cellulose fiber 2.

### <Low Molecular Weight Resin>

Low molecular weight resin 4 is required to be melted during kneading, and therefore is preferably a thermoplastic resin. Examples of the thermoplastic resin include olefin-based resins (including cyclic olefin-based resins), styrene-based resins, (meth) acrylic resins, organic acid vinyl ester-based resins or derivatives thereof, vinyl ether-based resins, halogen-containing resins, polycarbonate-based resins, polyester-based resins, polyamide-based resins, thermoplastic polyurethane resins, polysulfone-based resins (such as polyethersulfone and polysulfone), polyphenylene ether-based resins (such as polymers of 2,6-xylenol), cellulose derivatives (such as cellulose esters, cellulose carbamates, and cellulose ethers), silicone resins (such as polydimethylsiloxane and polymethylphenylsiloxane), rubbers or elastomers (such as diene rubbers including polybutadiene and polyisoprene, styrene-butadiene copolymers, acrylonitrile-butadiene copolymers, acrylic rubbers, urethane rubbers, and silicone rubbers), and waxes. The resin may be used alone or in combination of two or more thereof. Note that low molecular weight resin 4 is not limited to the above materials as long as it has thermoplastic properties.

The cellulose fiber composite resin composition according to the first exemplary embodiment includes: a base resin; a cellulose fiber; and a dispersant, wherein the cellulose fiber is contained in an amount of 50 mass % or more and 90 mass % or less, the cellulose fiber has an average particle diameter of 10 μm or more and 70 μm or less, a cellulose fiber having a particle diameter of 710 μm or less is included in a ratio of 95% or more, and a cellulose fiber having an aspect ratio (fiber length/fiber diameter) of 5 or more and 100 or less is included in a ratio of 95% or more. Specifically, the cellulose fiber is contained in an amount of 50 mass % or more and 90 mass % or less in the cellulose fiber composite resin composition. Among all the cellulose fibers, a cellulose fiber having a particle diameter of 710 μm or less is included in a ratio of 95% or more. Among all the cellulose fibers, a cellulose fiber having an aspect ratio of 5 or more and 100 or less is included in a ratio of 95% or more. The aspect ratio of the cellulose fiber is a ratio between the fiber length of the cellulose fiber and the fiber diameter of the cellulose fiber (fiber length/fiber diameter). The fiber length is the length of a fiber, and the fiber diameter is the diameter of a fiber. When the average particle diameter is less than 10 μm, the reinforcing effect by the cellulose fiber is reduced, and the mechanical properties of the composite resin are deteriorated. When the average particle diameter is more than 70 μm, the cellulose fibers easily come into contact with each other, and aggregates are easily formed. That is, when the average particle diameter of the cellulose fiber is 70 μm or less, the formation of aggregates of the cellulose fibers can be suppressed. The average particle diameter of the cellulose fiber may be 10 μm or more and 50 μm or less. In addition, when the aspect ratio is less than 5, the cellulose fiber is particulate and easily aggregates. On the other hand, when the aspect ratio exceeds 100, the cellulose fiber is a very long fiber, so that the fibers are easily entangled with each other and aggregates are easily formed. Therefore, the average particle diameter, the particle diameter, and the aspect ratio of the cellulose fiber are preferably within the above ranges.

The average particle diameter of the cellulose fiber can be measured by, for example, a measurement method such as a sieving method (JIS K 0069:1992), a laser diffraction/scattering method (JIS Z 8825:2013), or a dynamic light scattering method (JIS Z 8828:2013). That is, the average particle diameter of the cellulose fiber can be measured using a particle size distribution measuring device. In the sieving method, sieving is performed using two or more sieves different from each other in coarseness, and the particle diameter distribution is measured from the residual weight on each sieve. In the laser diffraction/scattering method, particles in a liquid or gas are irradiated with laser light, and the particle diameter is measured using the fact that the intensity pattern of scattered light scattered by the particles depends on the particle diameter. In the laser diffraction/scattering method, the diameter is measured as a spherical equivalent diameter. In the dynamic light scattering method, the particle diameter is measured by utilizing the Brownian motion of particles floating in a liquid. That is, a phase shift between the scattered light and the incident light caused by the Brownian motion is observed, and the particle diameter is calculated from the observed phase shift.

As the average particle diameter, for example, the median diameter D₅₀ at which the cumulative frequency in the obtained particle diameter distribution is 50% may be used. The above average particle diameter is shown using a median diameter D₅₀.

The aspect ratio of the cellulose fiber can be measured using, for example, a scanning electron microscope (SEM).

In the first exemplary embodiment, cellulose fiber 2 preferably includes a cellulose fiber that is bent at 90° or more in a ratio of 30% or less. When a cellulose fiber that is bent at 90° or more is included in a ratio of more than 30%, the bent cellulose fibers come into contact with each other and are easily entangled, so that aggregates are easily formed. Therefore, the ratio of a cellulose fiber that is bent at 90° or more is preferably within the above range.

For the cellulose fiber in the cellulose fiber composite resin molded body according to the first exemplary embodiment, in the skin layer at the surface of the composite resin molded body, preferably 80% or more, more preferably 90% or more of the cellulose fiber have a fiber length direction that is oriented at an angle θ of 0° or more and 30° or less against the surface of the composite resin molded body. The skin layer, positioned as the outermost surface of the molded body, particularly significantly affects the appearance. The cellulose fibers in the skin layer are oriented parallel to the skin layer. Thereby, contact between the cellulose fibers is suppressed, and the generation of aggregates is suppressed. On the other hand, when less than 80% thereof are oriented at an angle θ of 0° or more and 30° or less, the orientation of the cellulose fibers in the skin layer becomes random, the entanglement of the cellulose fibers increases, and aggregates are formed. Therefore, the ratio of the fiber length direction of the cellulose fiber oriented at an angle of 0° or more and 30° or less in the skin layer is preferably within the above range.

In the composite resin molded body according to the first exemplary embodiment, the molecular weight of low molecular weight resin 4 is preferably 1000 or more and 50000 or less, and more preferably 3000 or more and 30000 or less. When the molecular weight is less than 1000, the strength of the resin alone is weak, so that the strength of the entire composite resin is also greatly reduced. When the molecular weight is more than 50000, the viscosity of the resin alone becomes high, and the resin becomes difficult to enter the defibrated part of the cellulose fiber or the like, so that the effect of suppressing the generation of aggregates is deteriorated. Therefore, the molecular weight of low molecular weight resin 4 is preferably within the above range.

Low molecular weight resin 4 is contained in an amount of preferably 0.5 mass % or more and 20 mass % or less, and more preferably 1.0 mass % or more and 10 mass % or less, with respect to 100 mass % of the cellulose fiber. When low molecular weight resin 4 is contained in an amount of less than 0.5 mass %, the amount of the resin is too small, so that it is not possible to suppress contact between the cellulose fibers and to suppress generation of aggregates. In addition, the fluidity of the cellulose fiber cannot be improved. For more than 20 mass %, the amount of the low molecular weight resin is large relative to the amount of the cellulose fiber, so that the reinforcing effect cannot be sufficiently exhibited. Therefore, low molecular weight resin 4 is preferably contained within the above range.

### <Method for Producing Cellulose Fiber Composite Resin Composition>

The method for producing a cellulose fiber composite resin according to the first exemplary embodiment includes: a preparation step of preparing a base resin, a cellulose fiber, and a dispersant; and a kneading step of kneading the base resin, the cellulose fiber, and the dispersant to obtain a cellulose fiber composite resin composition.

In addition, a mixing step of adhering a low molecular weight resin having a powdery form or a liquid form to cellulose fiber 2 may be further included. When a low molecular weight resin having a powdery form or a liquid form is adhered to the surface of the cellulose fiber before the kneading step, the cellulose fibers are less likely to come into direct contact with each other, so that aggregation of the cellulose fibers can be suppressed. When the generation of aggregates can be suppressed before kneading, the generation of aggregates of the cellulose fibers can also be suppressed in the composite resin after kneading. When a resin pellet is used, the size thereof is significantly larger than that of the cellulose fiber. Therefore, even when the resin pellet and the cellulose fiber are mixed, the components are separated, and therefore aggregation of the cellulose fibers cannot be suppressed. Therefore, it is preferable that low molecular weight resin 4 is a powder or a liquid, and the mixing step is performed before the kneading step.

When low molecular weight resin 4 is a powdery resin, the average particle diameter thereof is preferably 100 μm or more and 1000 μm or less, and more preferably 200 μm or more and 500 μm or less. When the average particle diameter of the powdery resin is less than 100 μm, the difference from the average particle diameter of the cellulose fiber is small. Therefore, even when the powdery resin adheres to the surface of a cellulose fiber, the cellulose fiber cannot be prevented from contact with another cellulose fiber, and the generation of aggregates cannot be suppressed before kneading. In addition, when the average particle diameter of the powdery resin exceeds 1000 μm, the surface area of the powdery resin is reduced, so that the effect of suppressing aggregation of the cellulose fibers per mass amount is reduced. In addition, it is difficult to uniformly mix the cellulose fiber and the powdery resin. Therefore, the average particle diameter of the powdery resin of low molecular weight resin 4 is preferably within the above range.

In the method for producing a cellulose fiber composite resin composition according to the first exemplary embodiment, examples of the kneading apparatus to be used include a uniaxial kneader, a biaxial kneader, a roll kneader, a kneader, a Banbury mixer, and a combination thereof. From the viewpoint of easy application of high shear and high mass productivity, a continuous biaxial kneader and a continuous roll kneader are preferable. A kneading method other than the above may be used as long as high shear stress can be applied. In addition, the cellulose fiber is preferably kneaded at a temperature as low as possible because the cellulose fiber is easily deteriorated due to heat.

The cellulose fiber composite resin composition extruded from the kneading apparatus is subjected to a cutting process such as a pelletizer to be prepared in a pellet form. As a method of pelletizing, there are an air hot cut method, an underwater hot cut method, a strand cut method, and the like as a method performed immediately after melting of the resin. Alternatively, there is also a pulverization method that a molded body or a sheet is once molded and then pulverized and cut.

### <Method for Producing Cellulose Fiber Composite Resin Molded Body>

The pellet of the cellulose fiber composite resin composition is melted and injection-molded in a mold. Thereby, an injection-molded article can be produced as the cellulose fiber composite resin molded body.

Hereinafter, examples and comparative examples in experiments performed by the inventors will be described.

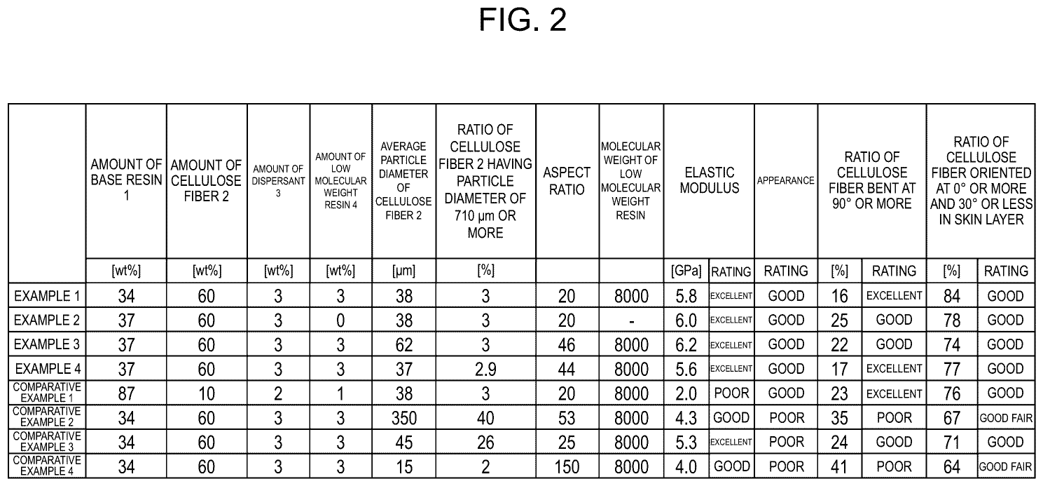

FIG. 2 shows conditions and measurement results of Examples 1 to 4 and Comparative Examples 1 to 4.

A cellulose fiber composite resin composition was produced by the following production method. As described above, examples of the kneading apparatus to be used include a uniaxial kneader, a biaxial kneader, a roll kneader, a kneader, a Banbury mixer, and a combination thereof. In the examples, a biaxial kneader was used.

Polypropylene (trade name: J108M, manufactured by Prime Polymer Co., Ltd.) as the base resin, a ground pulp as the cellulose fiber, maleic anhydride-modified polypropylene (trade name: UMEX, manufactured by Sanyo Chemical Industries, Ltd.) as the dispersant, and a low molecular weight polyolefin (trade name: Hi-Wax, manufactured by Mitsui Chemicals, Inc.) as the low molecular weight resin were used, and weighed at 33:60:3:3 in terms of mass ratio. A mixture of the base resin and the dispersant and a mixture of the ground pulp and the low molecular weight resin were separately supplied into the kneader. A broad-leaved tree pulp (product name: Mitsubishi Kitakami LBKP, manufactured by MITSUBISHI PAPER MILLS LIMITED) was used as a starting material for the ground pulp. The pulp was pulverized by a pulverizer to obtain the ground pulp. The size of the cellulose fiber and the like were adjusted by the pulverization process. The pulverization method is preferably dry pulverization because wet pulverization needs a drying process after pulverization and aggregation occurs during the drying. The average particle diameter of the cellulose fiber was measured using a sieving method.

The mixture was melt-kneaded and dispersed with a biaxial kneader (KRC kneader, manufactured by Kurimoto, Ltd.). The shearing force can be changed by changing the screw configuration of the biaxial kneader. In Example 1, the low-shear type specification was adopted. The composite resin discharged from the biaxial kneader was hot-cut to prepare a cellulose fiber composite resin pellet.

A test piece of the composite resin molded body was prepared using the prepared cellulose fiber composite resin pellet with an injection molding machine (180AD, manufactured by The Japan Steel Works, Ltd.). The preparation conditions of the dumbbell test piece were a resin temperature of 200° C., a mold temperature of 40° C., an injection speed of 60 mm/s, and a holding pressure of 100 MPa. The pellets were bit by the screw of the molding machine via the hopper, and the biting performance at that time was measured as the pellet decrease amount per hour, and it was confirmed that the biting performance was constant. The shape of the test piece was changed according to the evaluation items described below, and a No. 1 size dumbbell test piece was prepared for measuring the elastic modulus. A plate test piece of 2 mmt and 60 mm×70 mm was prepared for evaluation of appearance (aggregates). The obtained test piece of the cellulose fiber composite resin molded body was evaluated by the following methods.

### [Evaluation Items of Composite Resin Molded Body]

### (Elastic Modulus of Composite Resin Molded Body)

A three-point bending test was performed using the obtained No. 1 dumbbell-shaped test piece. Herein, as the method for evaluating the elastic modulus, a sample having a numerical value of less than 3.0 GPa was rated as Poor, a sample having a numerical value of 3.0 GPa or more and less than 3.5 GPa was rated as Fair, a sample having a numerical value of 3.5 GPa or more and less than 5.0 GPa was rated as Good, and a sample having a numerical value of 5.0 GPa or more was rated as Excellent. The test piece had an elastic modulus of 5.8 GPa, and rated as Excellent.

### (Appearance of Composite Resin Molded Body)

Using the obtained plate test piece, the appearance of the composite resin molded body was visually evaluated. The case where the plate test piece has 3 or more visually recognizable aggregates in a region of 60 mm×70 mm was rated as Poor, the case where 1 or 2 are recognized was rated as Fair, and the case where none is recognized was rated as Good. The test piece had no visually recognizable aggregate, and rated as Good.

### (Evaluation of Bending Degree of Cellulose Fiber in Composite Resin Molded Body)

From the obtained No. 1 dumbbell-shaped test piece, a part thereof was cut out for SEM observation. The case where a cellulose fiber that is bent at 90° or more is included in the resin in a ratio of 30% or more was rated as Poor, the case where the ratio is 20% or more and less than 30% was rated as Good, and the case where the ratio is less than 20% was rated as Excellent. In the test piece, a cellulose fiber that is bent at 90° or more was included in a ratio of 16%, which was rated as Excellent.

### (Orientation of Fiber in Skin Layer)

From the obtained No. 1 dumbbell-shaped test piece, a part thereof was cut out for polarization microscope measurement of the cross section. In the obtained polarization microscope measurement image, the angle of the fiber length direction of the cellulose fiber in the skin layer was measured, the surface of the test piece being 0°. The case where less than 50% of the cellulose fiber have a fiber length direction that has an angle of 0° or more and 30° or less against the surface was rated as Poor, the case of 50% or more and less than 70% was rated as Fair, and the case where 70% or more was rated as Good. In the test piece, the ratio of the cellulose fiber at 0° or more and 30° or less was 84%, which was rated as Good.

### Example 2

In Example 2, the low molecular weight resin was not used, and the mass ratio of base resin:cellulose fiber:dispersant:low molecular weight resin was changed to 37:60:3:0. A cellulose fiber composite resin pellet and a molded body were prepared under the same conditions as in Example 1 except for the above. The evaluation was performed in the same manner as in Example 1.

### Example 3

In Example 3, as the cellulose fiber, a ground pulp having a larger average particle diameter and a larger aspect ratio than in Example 1 was used. A cellulose fiber composite resin pellet and a molded body were prepared under the same material conditions and process conditions as in Example 1 except for the above. The evaluation was performed in the same manner as in Example 1.

### Example 4

In Example 4, as the cellulose fiber, a powdery pulp obtained by mixing 95 mass % of the powdery pulp used in Example 1 with 5 mass % of a powdery pulp having an average particle diameter of 20 μm and an aspect ratio of 5 was used. A cellulose fiber composite resin pellet and a molded body were prepared under the same material conditions and process conditions as in Example 1 except for the above. The evaluation was performed in the same manner as in Example 1.

### Comparative Example 1

In Comparative Example 1, the mass ratio of base resin:ground pulp:dispersant was changed to 88:10:2. A composite resin pellet and a molded body were prepared under the same material conditions and process conditions as in Example 1 except for the above. The evaluation was performed in the same manner as in Example 1.

### Comparative Example 2

In Comparative Example 2, as the cellulose fiber, a ground pulp having an average particle diameter of 350 μm, which is larger than in Example 1, was used. A composite resin pellet and a molded body were prepared under the same material conditions and process conditions as in Example 1 except for the above. The evaluation was performed in the same manner as in Example 1.

### Comparative Example 3

In Comparative Example 3, as the cellulose fiber, a ground pulp in which the ratio of the particle diameter of 710 μm is higher than in Example 1 was used. A cellulose fiber composite resin pellet and a molded body were prepared under the same material conditions and process conditions as in Example 1 except for the above. The evaluation was performed in the same manner as in Example 1.

### Comparative Example 4

In Comparative Example 4, as the cellulose fiber, a ground pulp having an aspect ratio of 150, which is larger than in Example 1, was used. A plant fiber composite resin pellet and a molded body were prepared under the same material conditions and process conditions as in Example 1 except for the above. The evaluation was performed in the same manner as in Example 1.

The measurement results in Examples 1 to 4 and Comparative Examples 1 to 4 are shown in the table in FIG. 2.

In Example 2, in which the low molecular weight resin was not used, the fluidity of the cellulose fiber was lower than in Example 1. Therefore, the ratio of cellulose fibers bent at 90° or more was 23%, which was rated as Good. On the other hand, since there was no low molecular weight resin component having low mechanical properties, the elastic modulus was 6.0 GPa.

In Example 3, in which a ground pulp having an average particle diameter of 62 μm and an aspect ratio of 46 was used, the particle diameter was not so large as compared with Example 1, and the aspect ratio was large, so that the reinforcing effect was increased and the elastic modulus was 6.2 GPa, which was rated as Excellent.

In Example 4, in which two types of ground pulp were used, the ratio of a cellulose fiber having a small particle diameter and a small aspect ratio increased, and therefore the elastic modulus decreased to 5.6 GPa.

In Comparative Example 1, in which the mass ratio of the cellulose fiber to the whole raw materials was reduced, the amount of the cellulose fiber was small, so that the reinforcing effect of the filler on the composite resin was reduced, and the elastic modulus was 1.8 GPa, which was rated as Poor.

In Comparative Example 2, in which a cellulose fiber having a large average particle diameter was used, the cellulose fibers were in contact with each other, and the number of generated aggregates increased, which was rated as Poor.

In Comparative Example 3, in which a cellulose fiber in which the ratio of the particle diameter of 710 μm is higher was used, the amount of generated aggregates was increased mainly from cellulose fibers having a large particle diameter, which was rated as Poor.

In Comparative Example 4, in which a cellulose fiber having a large aspect ratio was used, the aspect ratio was large, and the ratio of bent portions of the cellulose fiber was also large, so that contact and entanglement between fibers increased, and the number of aggregates increased, which was rated as Poor.

From the above evaluation, when the cellulose fiber was contained in an amount of less than 50 mass %, the strength of the composite resin did not reach the required level. On the other hand, when a cellulose fiber having an average particle diameter of 50 μm or more was used, when a cellulose fiber in which the ratio of a cellulose fiber having a particle diameter of 710 μm or less is less than 95% was used, or when a cellulose fiber having an aspect ratio of 100 or more was used, the entanglement of cellulose fibers was increased, and the generation of aggregates could not be suppressed.

From the above, it has been found that the cellulose fiber composite resin composition can suppress the generation of aggregates, has good appearance, and has high mechanical strength, when the cellulose fiber composite resin composition includes: a base resin; a cellulose fiber; and a dispersant, wherein the cellulose fiber is contained in an amount of 50 mass % or more and 90 mass % or less, the cellulose fiber has an average particle diameter of 10 μm or more and 50 μm or less, a cellulose fiber having a particle diameter of 710 μm or less is included in a ratio of 95% or more, and the aspect ratio (fiber length/fiber diameter) is 5 or more and 100 or less.

### INDUSTRIAL APPLICABILITY

The cellulose fiber composite resin composition according to the present disclosure can provide a material molded body that is superior in mechanical strength to conventional general-purpose resins, has no appearance defects such as white spots and black spots caused by aggregates of cellulose fibers, and has a good appearance. The cellulose fiber composite resin molded body according to the present disclosure can be used for external components that require an excellent mechanical strength and an excellent appearance, such as housings of household electric appliances, building materials, and automobile components.

### REFERENCE MARKS IN THE DRAWINGS

1 Base resin
2 Cellulose fiber
3 Dispersant
4 Low molecular weight resin
10 Cellulose fiber composite resin molded body
11 Skin layer
12 Core layer

1. A cellulose fiber composite resin composition comprising: a base resin; a cellulose fiber; and a dispersant,
wherein
the cellulose fiber is contained in an amount of 50 mass % or more and 90 mass % or less,
the cellulose fiber has an average particle diameter of 10 μm or more and 70 μm or less,
the cellulose fiber includes a cellulose fiber having a particle diameter of 710 μm or less in a ratio of 95% or more, and
the cellulose fiber includes a cellulose fiber having an aspect ratio of 5 or more and 100 or less in a ratio of 95% or more, the aspect ratio being a ratio between a fiber length of a cellulose fiber and a fiber diameter of a cellulose fiber.

2. The cellulose fiber composite resin composition according to claim 1, wherein the cellulose fiber includes a cellulose fiber that is bent at 90° or more in a ratio of 30% or less.

3. The cellulose fiber composite resin composition according to claim 1, further comprising a low molecular weight resin having a molecular weight of 1000 or more and 50000 or less.

4. The cellulose fiber composite resin composition according to claim 3, wherein the low molecular weight resin is contained in an amount of 0.5 mass % or more and 20 mass % or less with respect to 100 mass % of the cellulose fiber.

5. A cellulose fiber composite resin molded body comprising the cellulose fiber composite resin composition according to claim 1.

6. The cellulose fiber composite resin molded body according to claim 5, wherein, in a skin layer including a surface of the cellulose fiber composite resin molded body, 70% or more of the cellulose fiber have a fiber length direction that is oriented at an angle of 0° or more and 30° or less against the surface of the cellulose fiber composite resin molded body.

7. A method for producing a cellulose fiber composite resin composition, the method comprising:
a preparation step of preparing a base resin, a cellulose fiber, and a dispersant; and
a kneading step of kneading the base resin, the cellulose fiber, and the dispersant to obtain a cellulose fiber composite resin composition.

8. The method for producing a cellulose fiber composite resin composition according to claim 7, further comprising a mixing step of adhering an additive resin having a powdery form or a liquid form to the cellulose fiber.

9. The method for producing a cellulose fiber composite resin composition according to claim 8, wherein the additive resin is a powdery resin having an average particle diameter of 100 μm or more and 1000 μm or less.
